(19) United States
(12) Patent Application Publication
(10) Pub. No.: US 2025/0100859 A1
(43) Pub. Date: Mar. 27, 2025

(54) TRANSFER CONTROL SYSTEM, TRANSFER CONTROL APPARATUS, AND TRANSFER CONTROL METHOD

(71) Applicant: NEC Corporation, Minato-ku, Tokyo (JP)

(72) Inventor: Ryutaro YAMAGUCHI, Tokyo (JP)

(73) Assignee: NEC Corporation, Minato-ku, Tokyo (JP)

(21) Appl. No.: 18/728,972

(22) PCT Filed: Feb. 4, 2022
(86) PCT No.: PCT/JP2022/004550

§ 371 Date: Jul. 15, 2024

(51) Int. Cl. B66F 9/24

(52) U.S. Cl. CPC B66F 9/24

(57) ABSTRACT

A transfer control system or a transfer control apparatus controls lifting or lowering of a loading portion that loads an object in a mobile body that conveys an object. The transfer control system or the transfer control apparatus acquires a load amount of the loading portion, and information regarding a first height that is a height of a place where the object is moved to and from the loading portion. The transfer control system or the transfer control apparatus specifies, based on the first height, a second height that is one of the heights for lifting or lowering the loading portion and is higher than the first height. The transfer control system or the transfer control apparatus performs a first lifting or lowering control of lifting or lowering the loading portion according to the load amount between a first height and a second height above the place.

### TECHNICAL FIELD

The present disclosure relates to a transfer control system, a transfer control apparatus, and a transfer control method.

### BACKGROUND ART

A method of determining an installation surface on which cargo is installed when a forklift installs cargo, and a method of determining a loading surface of cargo when the cargo is loaded on a fork of the forklift have been proposed.

For example, Patent Literature 1 describes a technique of determining the presence of a loading surface based on a measured value of a distance meter that moves up and down together with a fork, and controlling a hydraulic mechanism to raise the fork by a specified amount and then stopping the fork. In the technique described in Patent Literature 1, in a case where the measured value of the distance meter is a value greater than or equal to a predetermined first specified value, and changes in the order of a value less than the first specified value, and a value greater than or equal to a second specified value, it is determined that the loading surface exists at a height at which a value less than the first specified value has switched to a value greater than or equal to the first specified value.

In addition, Patent Literature 2 discloses a forklift including a lifting or lowering operation sensor for detecting a lifting or lowering operation of a fork, a lifting or lowering actuator that performs a lifting or lowering operation of the fork, and an inclination actuator that performs an inclination operation of the fork. The forklift described in Patent Literature 2 further includes a load sensor for detecting a load of the lifting or lowering actuator, an inclination sensor for detecting an inclination of the fork, and a control unit. The control unit drives and controls the inclination actuator based on detection signals of the lifting or lowering operation sensor, the load sensor, and the inclination sensor to adjust the horizontality of the fork. In the technique described in Patent Literature 2, as to whether the cargo is grounded, the lowering drive pressure of the lifting or lowering actuator (lifting or lowering hydraulic cylinder) is detected by a load sensor, and the control unit determines that the cargo is grounded at the time point when the lowering drive pressure decreases to exceed a predetermined value.

### CITATION LIST

### Patent Literature

Patent Literature 1: Japanese Unexamined Patent Application Publication No. 2021-004113
Patent Literature 2: Japanese Unexamined Patent Application Publication No. 2017-043469

### SUMMARY OF INVENTION

### Technical Problem

However, in the technique described in Patent Literature 1, in a case where the height of the loading surface is measured, there is a possibility that it is not possible to cope with a situation in which the height of the loading surface changes while the cargo is loaded due to the weight of the cargo. For example, in a case where the height of the load surface changes due to the weight of the cargo while the cargo is being moved based on the measured height of the loading surface, it is conceivable that the lowering of the fork be stopped and the fork be pulled out even though the cargo is not separated from the fork. In that case, cargo cannot be installed.

In addition, in the technique described in Patent Literature 2, the grounding of the cargo is determined using the lowering driving pressure, but in this technique, there is a possibility that the work efficiency deteriorates. For example, in order to avoid damage to the loading platform or the cargo caused by quickly lowering the fork to a position where the lowering drive pressure becomes equal to or less than the threshold value, it is necessary to set a lowering speed of the fork to be low and confirm the lowering drive pressure.

As described above, in the techniques described in Patent Literature 1 and Patent Literature 2, in a situation where there are changes with respect to the installation surface changes depending on the weight of the cargo, such as in a loading platform of a truck, it is not possible to efficiently install the cargo or load the cargo on the fork.

In view of the above circumstances, an object of the present disclosure is to provide a transfer control system, a transfer control apparatus, and a transfer control method capable of efficiently installing an object or loading an object on a mobile body in a situation where an installation surface changes depending on a weight of the object to be conveyed.

### Solution to Problem

In order to achieve the above object, the present disclosure provides, as a first aspect, a transfer control system. The transfer control system includes lifting or lowering control means for controlling lifting or lowering of loading means for loading an object in a mobile body for conveying the object, load amount acquisition means for acquiring a load amount of the loading means, acquisition means for acquiring information relating to a first height that is a height of a place where the object is moved to and from the loading means, and specification means for specifying a second height that is one of heights for lifting or lowering the loading means and is higher than the first height based on the first height, in which the lifting or lowering control means performs a first lifting or lowering control of lifting or lowering the loading means according to the load amount between the first height and the second height above the place.

The present disclosure provides, as a second aspect, a transfer control apparatus. The transfer control apparatus includes lifting or lowering control means for controlling lifting or lowering of loading means for loading an object in a mobile body for conveying the object, load amount acquisition means for acquiring a load amount of the loading means, acquisition means for acquiring information relating to a first height that is a height of a place where the object is moved to and from the loading means, and specification means for specifying a second height that is one of heights for lifting or lowering the loading means and is higher than the first height based on the first height, in which the lifting or lowering control means performs a first lifting or lowering control of lifting or lowering the loading means according to the load amount between the first height and the second height above the place.

The present disclosure provides, as a third aspect, a transfer control method. The transfer control method includes lifting or lowering control of controlling lifting or lowering of loading means for loading an object in a mobile body for conveying the object, load amount acquisition processing of acquiring a load amount of the loading means, acquisition processing of acquiring information relating to a first height that is a height of a place where the object is moved to and from the loading means, and specification processing of specifying a second height that is one of heights for lifting or lowering the loading means and is higher than the first height based on the first height, in which the lifting or lowering control includes a first lifting or lowering control of lifting or lowering the loading means according to the load amount between the first height and the second height above the place.

### Advantageous Effects of Invention

According to the present disclosure, it is possible to provide a transfer control system, a transfer control apparatus, and a transfer control method capable of efficiently installing or loading an object in a situation where an installation surface changes depending on a weight of the object to be conveyed.

### BRIEF DESCRIPTION OF DRAWINGS

FIG. 1 is a block diagram illustrating a configuration example of a transfer control system according to a first example embodiment of the present disclosure.

FIG. 2 is a block diagram illustrating a transfer control apparatus as a configuration example of the transfer control system of FIG. 1.

FIG. 3 is a flowchart for illustrating an example of a transfer control method in the transfer control system of FIG. 1 or the transfer control apparatus of FIG. 2.

FIG. 4 is a block diagram illustrating a detailed configuration example of the transfer control system of FIG. 1.

FIG. 5 is a side view schematically illustrating an example of a forklift that is a control target of a transfer control in the transfer control system of FIG. 4.

FIG. 6 is a schematic view for illustrating an example of a procedure for lowering an object from a fork in the transfer control system of FIG. 4.

FIG. 7 is a flowchart for illustrating a processing example in the transfer control system in a case where an object is lowered by the procedure of FIG. 6.

FIG. 8 is a schematic diagram for illustrating an example of a procedure for loading an object on a fork in the transfer control system of FIG. 4.

FIG. 9 is a flowchart for illustrating a processing example in the transfer control system in a case where an object is loaded by the procedure of FIG. 8.

FIG. 10 is a flowchart for illustrating an example of a transfer control method in a transfer control system according to a second example embodiment of the present disclosure.

FIG. 11 is a flowchart for illustrating another example of a transfer control method in the transfer control system according to the second example embodiment of the present disclosure.

FIG. 12 is a block diagram illustrating a configuration example of a transfer control system according to a third example embodiment of the present disclosure.

FIG. 13 is a block diagram illustrating a configuration example of an apparatus.

### EXAMPLE EMBODIMENT

Hereinafter, example embodiments according to the present disclosure will be described in detail with reference to the drawings. Note that in the description and drawings to be described below, omission and simplification are made as appropriate, for clarity of description. In addition, in each of the drawings described below, the same elements and similar elements are denoted by the same reference signs, and a duplicate description is omitted as necessary.

### First Example Embodiment

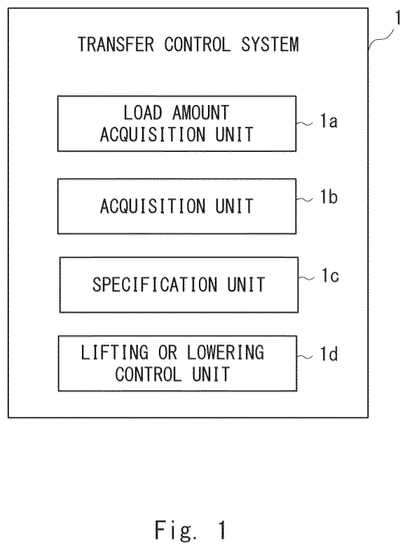

A first example embodiment will be described with reference to FIGS. 1 to 9. First, a configuration and processing according to the present example embodiment will be described with reference to FIGS. 1 to 3. FIG. 1 is a block diagram illustrating a configuration example of a transfer control system according to the present example embodiment.

A transfer control system 1 according to the present example embodiment illustrated in FIG. 1 is a system that transfers an object by controlling a mobile body that conveys the object, such as a lift apparatus such as a forklift, and can also be referred to as a load handling control system. Hereinafter, a forklift will be described as an example of the mobile body, but the mobile body is not limited thereto, and any apparatus may be used as long as the apparatus conveys the object. The transfer control system 1 can also be constructed as a system including a mobile body such as a forklift. Note that, in the present disclosure, “moving the object to and from the loading means (loading units)” refers to moving the object, and includes at least one of transfer of the object from the mobile body to the placement place and transfer of the object from the loading place to the mobile body.

As illustrated in FIG. 1, the transfer control system 1 according to the present example embodiment can include a load amount acquisition unit (load amount acquisition means) la, an acquisition unit (acquisition means) 1b, a specification unit (specification means) 1c, and a lifting or lowering control unit (lifting or lowering control means) 1d. In the transfer control system 1, the load amount acquisition unit 1a, the acquisition unit 1b, the specification unit 1c, and the lifting or lowering control unit 1d can be mounted in a plurality of apparatuses in a distributed manner, and a distribution method thereof is not limited. For example, the transfer control system 1 can include an apparatus including the load amount acquisition unit 1a, an apparatus including the acquisition unit 1b, an apparatus including the specification unit 1c, and an apparatus including the lifting or lowering control unit 1d. Each apparatus may include a computer apparatus including hardware including, for example, one or more processors and one or more memories. Then, at least some of functions of the units mounted in each apparatus may be implemented in such a way that one or more processors operate in accordance with a program read from one or more memories.

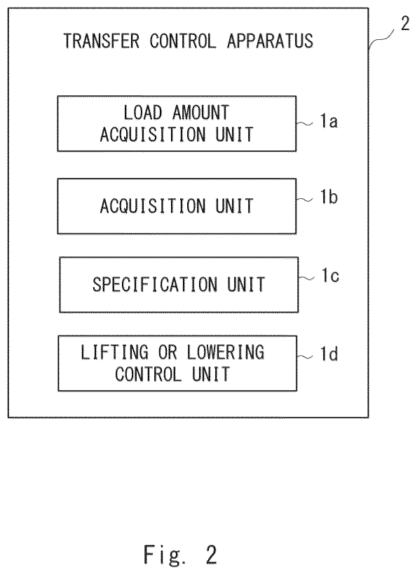

In addition, as illustrated in FIG. 2, the transfer control system 1 can also be constructed as one transfer control apparatus 2 including the load amount acquisition unit 1a, the acquisition unit 1b, the specification unit 1c, and the lifting or lowering control unit 1d. FIG. 2 is a block diagram illustrating the transfer control apparatus 2 as a configuration example of the transfer control system 1 of FIG. 1. The transfer control apparatus 2 may be configured as a computer apparatus including hardware including, for example, one or more processors and one or more memories. Then, at least some of functions of the units mounted in the transfer control apparatus 2 may be implemented in such a way that one or more processors operate in accordance with a program read from one or more memories. Further, the transfer control apparatus 2 may be implemented in such a way that the functions of the respective units are distributed to separate apparatuses, and a distribution method thereof is not limited. For example, the transfer control apparatus 2 can include an apparatus including the load amount acquisition unit 1a, an apparatus including the acquisition unit 1b, an apparatus including the specification unit 1c, and an apparatus including the lifting or lowering control unit 1d.

Next, the load amount acquisition unit 1a, the acquisition unit 1b, the specification unit 1c, and the lifting or lowering control unit 1d will be described.

The load amount acquisition unit 1a acquires a load amount of a loading unit (loading means) for loading a conveyance object (hereinafter, the object) in the forklift. Here, loading an object can refer to applying a load to the object, such as loading the object, gripping and lifting the object on the lower side of a projection portion or the like of the object, or hanging and lifting the object by hooking a hanging tool on a part of the object. The loading unit refers to a place where the load is applied. In a case of a forklift, loading an object on the fork refers to loading the object on the fork, and the loading unit refers to a fork. Other examples will be described later.

The load amount acquisition unit 1a measures the load amount on the loading unit due to loading of the object to obtain the measurement result or may be configured to be able to obtain the measurement result. For example, the load amount acquisition unit 1a may calculate the load amount related to the fork from the pressure of the hydraulic cylinder that controls the lifting or lowering of the fork. As in this example, the load amount of the loading unit can also be detected at another portion connected to the loading unit. In addition, the load amount acquisition unit 1a can be configured to include a sensor such as a weight sensor and receive the load amount detected by the sensor, but for example, the sensor itself can be configured not to be included in the load amount acquisition unit 1a. A detection method of the load amount is not limited.

In addition, the loading unit can be, for example, a carrying portion (i.e., loading portion) on which an object is carried (i.e., loaded), a support portion that supports the object at a plurality of points, or the like, and can also be referred to as a laden portion. The loading unit is a portion for lifting an object. The loading unit corresponds to a fork on which an object is loaded in the case of a forklift, and the fork will be described below as an example. In addition, in a case where the mobile body is a forklift, the object to be conveyed can refer to the cargo loading pallet and the cargo loaded thereon. The cargo loading pallet may include a frame that forms a space for inserting the fork from the horizontal direction. Note that the object to be conveyed without using the cargo loading pallet is the cargo itself.

The acquisition unit 1b acquires information regarding a first height that is a height of a place where the object is moved to and from the fork. Since this place is a place where an object is transferred to and from the fork, this place will be hereinafter referred to as a “transfer place”. The acquisition unit 1b can be configured to include a height sensor for detecting the height and receive the detection result, but for example, the height sensor itself can be configured not to be included in the acquisition unit 1b.

The height of the transfer place may be the height of the surface of the loading platform in a case where the transfer destination or the transfer source is the loading platform of the truck, or may be the height obtained by adding the height (thickness) of the frame in a case where the cargo loading pallet also has a plate-shaped frame on the bottom.

In the present example embodiment, a scene where an object is moved from a forklift to a transfer destination such as a truck and a scene where an object is moved from a transfer source such as a truck to a fork of the forklift can be assumed. Of course, the forklift according to the present example embodiment can also target movement (transfer) to a transfer destination or a transfer source whose height to the ground or the like is fixed. However, the present example embodiment can be effectively applied to transfer to a loading platform or the like of a truck whose height is not fixed, or transfer to a transfer destination or a transfer source in which a plurality of objects are stacked even in a case where the height of the ground or the like is fixed.

In addition, the height sensor may be installed at a high position on a ceiling or a wall as long as it is indoors, or may be installed at a high position on a pole or an outer wall of a building as long as it is outdoors, or may be installed on a forklift regardless of whether it is indoors or outdoors. In addition, the height sensor may be, for example, a laser sensor such as LiDAR (registered trademark) or an infrared time-of-flight (ToF) camera. As can be seen from this example, the method of measuring the height in the height sensor is not limited.

The specification unit 1c specifies, based on the first height, a second height that is one of the heights for lifting or lowering the fork and is higher than the first height. The first height can be the information itself acquired by the acquisition unit 1b or be calculated from the information. As can be seen from the following description, the second height is one control target height for moving the fork. However, the control target here does not refer to a final control target. In addition, moving the fork refers to lifting or lowering the fork.

The lifting or lowering control unit 1d controls lifting or lowering of the fork. In particular, the lifting or lowering control unit 1d performs a first lifting or lowering control of lifting or lowering the fork according to the load amount acquired by the load amount acquisition unit 1a between the first height and the second height above the transfer place. The upper side of the transfer place refers to the upper side of the loading platform in a case where the transfer destination or the transfer source is the loading platform of the truck, and the first lifting or lowering control is applied to lifting or lowering of the fork on the upper side of the loading platform. In addition, the load amount to be used can also be a decrease amount of the load amount. The decrease amount of the load amount can be calculated by comparing the load amount at the time of conveying the object or loading the object on the fork with the load amount in the current work. In addition, the decrease amount of the load amount can also be calculated by acquiring the load amount of the object being conveyed from the outside and comparing the acquired load amount of the object being conveyed with the load amount in the current work.

Of course, the lifting or lowering control unit 1d can perform lifting or lowering control other than the first lifting or lowering control according to the scene, and such lifting or lowering control is hereinafter referred to as a second lifting or lowering control. Various known lifting or lowering control can be adopted regardless of a control method performed by the second lifting or lowering control.

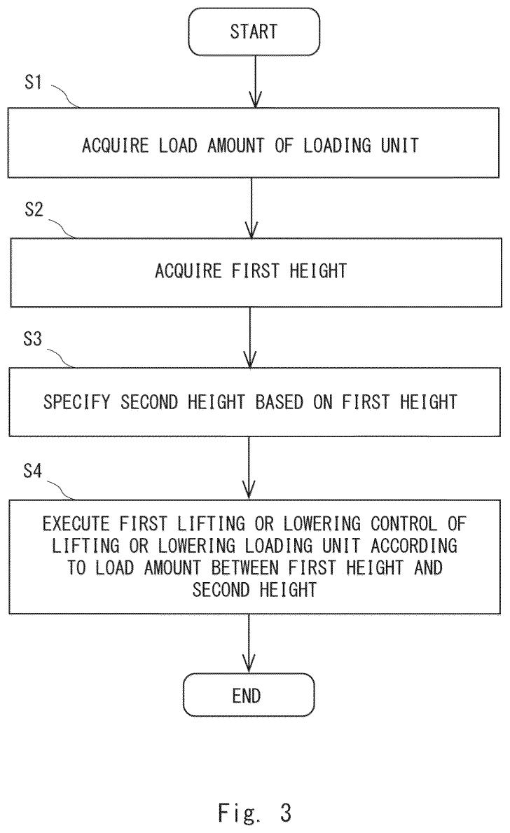

Next, a transfer control method in the transfer control system 1 or the transfer control apparatus 2 having the above-described configuration will be described with reference to FIG. 3. FIG. 3 is a flowchart for illustrating an example of the transfer control method.

In this transfer control method, the load amount acquisition unit 1a executes load amount acquisition processing of acquiring a load amount of the loading unit such as a fork (step S1). Next, the acquisition unit 1b executes acquisition processing of acquiring information regarding the first height (step S2), and the specification unit 1c executes specification processing of specifying the second height based on the first height (step S3). The processing of step S1 can also be executed after step S2 or after step S3. Finally, the lifting or lowering control unit 1d executes a first lifting or lowering control of lifting or lowering the loading unit according to the load amount between the first height and the second height (step S4). Note that the lifting or lowering control unit 1d can perform the second lifting or lowering control except during the first lifting or lowering control.

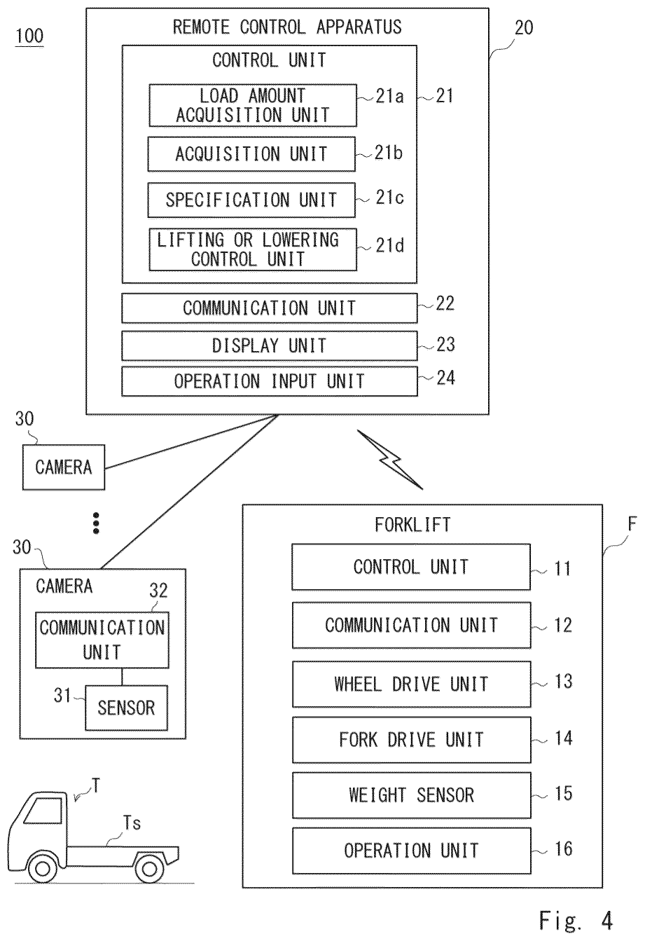

Detailed examples of the first lifting or lowering control and the second lifting or lowering control will be described with reference to FIGS. 4 to 9, but in the present example embodiment, the following effects are obtained by performing such a first lifting or lowering control. That is, in the present example embodiment, even in a situation where the installation surface changes depending on the weight of the object, not only the load on the fork is measured, but also the height of the installation surface is measured, whereby the work of lowering the object from the fork (work of installing the object) can be made efficient. Furthermore, in the present example embodiment, even in a situation where the loading surface changes depending on the weight of the object, the work of loading the object on the fork can be made efficient by measuring not only the load on the fork but also the height of the loading surface.

As described above, according to the present example embodiment, it is possible to efficiently install the object or load the object on the fork in a situation where the installation surface changes depending on the weight of the conveyance object.

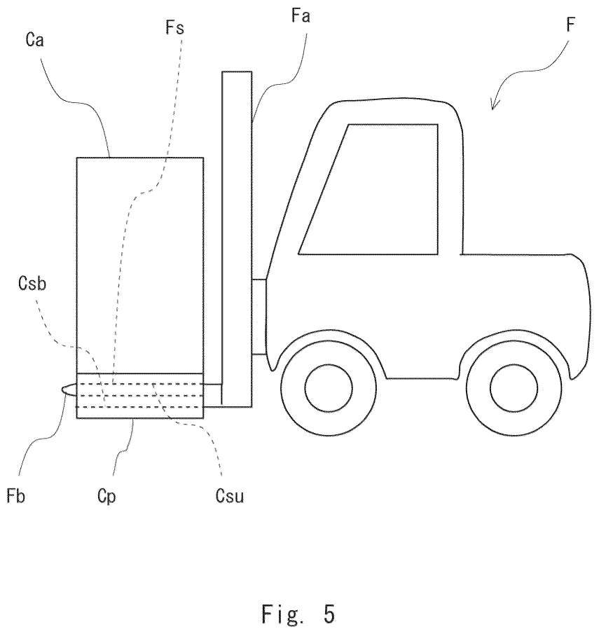

Next, a detailed configuration example of the transfer control system 1 of FIG. 1 will be described with reference to FIGS. 4 to 9. First, an overview of this configuration example will be described with reference to FIGS. 4 and 5. FIG. 4 is a block diagram illustrating a detailed configuration example of the transfer control system 1 of FIG. 1. FIG. 5 is a side view schematically illustrating an example of a forklift that is a control target of a transfer control in the transfer control system of FIG. 4.

The transfer control system 100 illustrated in FIG. 4 can include one or a plurality of forklifts F, the remote control apparatus 20 which is an example of the transfer control apparatus 1, and one or a plurality of ToF cameras 30 (hereinafter, simply refer to cameras). In addition, a truck T in FIG. 4 is a truck having a loading platform as a transfer destination or a transfer source exemplified herein.

A camera 30 is connected to the remote control apparatus 20 in a wired or wireless manner. The camera 30 can be installed at one or more locations, such as a ceiling where the first height is measurable. The camera 30 can include a sensor 31 such as a light receiving element, and a communication unit 32 that transmits sensor data detected by the sensor 31 or distance data calculated therefrom to the remote control apparatus 20. Of course, a height sensor other than the ToF camera can be adopted instead of the camera 30.

In addition, one or a plurality of forklifts F are wirelessly connected to the remote control apparatus 20 as a control target. Hereinafter, one forklift F will be described as a control target, but other forklifts can be similarly controlled.

The forklift F can include a control unit 11 that controls the entire forklift, a communication unit 12 that performs wireless communication with the remote control apparatus 20, a wheel drive unit 13 that drives the wheel, a fork drive unit 14 that drives the fork, a weight sensor 15, and an operation unit 16. The control unit 11 may be configured as a computer apparatus including hardware including, for example, one or more processors and one or more memories. Then, at least some of functions of the units mounted in the forklift F may be implemented in such a way that one or more processors operate in accordance with a program read from one or more memories. Note that the communication unit 12 can also be configured to be directly wirelessly connected to the camera 30.

As illustrated in FIG. 5, the forklift F can include, on the front side of the main body, a lift portion Fa which is a part of the fork drive unit 14, and a fork Fb which is attached so as to be movable up and down by the lift portion Fa. The lift portion Fa can be configured by, for example, a lift cylinder, a lift chain, or the like, but various existing mechanisms can be applied. Other portions of the fork drive unit 14, for example, a motor that provides power for lifting or lowering the fork Fb with respect to the lift portion Fa, a driving source such as an engine, and the like can be provided on the main body side of the forklift F. In FIG. 5, the fork Fb has a loading surface Fs serving as a surface on which cargo loading pallet Cp, which is a part of the object, is loaded, and the weight sensor can be installed on a loading surface Fs.

The cargo loading pallet Cp includes an upper frame, a lower frame, and a pair of side surface frames connecting the upper frame and the lower frame, and can form one or a plurality of spaces. By inserting the fork Fb into this space, it is possible to load an object including the cargo loading pallet Cp, that is, the cargo loading pallet Cp and the cargo Ca loaded thereon in the example of FIG. 5. When the fork Fb loads and lifts the object, the lower surface Csu of the upper frame comes into contact with the loading surface Fs, and the weight sensor 15 can detect the weight. The upper surface Csb of the lower frame is a surface that comes into contact with the lower surface of the fork Fb when the fork Fb is lowered to the lower side. However, some of the cargo loading pallets do not include the lower frame.

The wheel drive unit 13 drives a wheel for moving the entire forklift F. The fork drive unit 14 can include the lift portion Fa, a driving source, and the like as described above. The weight sensor 15 is an example of a sensor that detects a load amount.

The operation unit 16 receives a driving operation in a case of manually driving the forklift F, and can include a steering wheel, a lever, and the like. It is also possible to attach an attachment including an actuator that enables automatic driving to the operation unit 16, control the actuator, and operate the operation unit 16 to enable automatic driving. In a case where the forklift F is a forklift dedicated to autonomous movement, the operation unit 16 is unnecessary.

In addition, the forklift F can be a counter forklift in which the position of the fork in the horizontal direction is fixed. Although such an example is given, the forklift F can also be a reach forklift in which the fork extends and contracts in the horizontal direction.

The remote control apparatus 20 can include a control unit 21 that controls the entire apparatus, a communication unit 22 that communicates with the camera 30 and the forklift F, a display unit 23 that displays an operation image for remote operation, and an operation input unit 24 that operates the operation image.

The control unit 21 can include a load amount acquisition unit 21a, an acquisition unit 21b, a specification unit 21c, and a lifting or lowering control unit 21d corresponding to the load amount acquisition unit 1a, the acquisition unit 1b, the specification unit 1c, and the lifting or lowering control unit 1d, respectively. The control unit 21 may be configured as a computer apparatus including hardware including, for example, one or more processors and one or more memories. Then, at least some of functions of the units mounted in the remote control apparatus 20 may be implemented in such a way that one or more processors operate in accordance with a program read from one or more memories.

The load amount acquisition unit 21a acquires the load amount of the fork Fb on which the object of the forklift F is loaded. The load amount acquisition unit 21a can be configured to acquire the load amount, in this example, the weight detected by the weight sensor 15, via the communication unit 22.

The acquisition unit 21b receives, from the camera 30 via the communication unit 22, information regarding a first height (height H1 to be described later) that is the height of the transfer place where the object is moved to and from the fork Fb. Note that from which camera 30 the information obtained is acquired, one or a plurality of cameras 30 capable of detecting the height of the loading platform of the truck at the position can be designated by designating the position of the truck to be transferred by the forklift F, or the like. In this manner, the first height can also be obtained from information obtained from two or more cameras 30.

In a case where the loading platform of the truck T illustrated in FIG. 4 is a transfer destination or a transfer source, the first height may be the height of the surface Ts of the loading platform, or in a case where the cargo loading pallet Cp also includes a plate-like frame on the lower side as illustrated, the first height may be the height obtained by adding the thickness of the frame.

In this manner, the acquisition unit 21b can acquire, as the information regarding the first height, a measurement value obtained by measuring the height of the surface of the object to be moved with respect to the fork Fb. However, in a case where the current height of the loading platform of the truck is obtained as information, the acquisition unit 21b can be configured to acquire the information. In addition, instead of the camera 30, for example, a height sensor such as the camera 30 may be provided above the lift portion Fa of the forklift F, or a height sensor attached to a higher position of the forklift F via a pole or the like may be separately provided.

The specification unit 21c specifies a second height (height H2 to be described later) that is one of the heights at which the fork is moved (lifted or lowered) and is higher than the first height based on the first height acquired by the acquisition unit 21b. In particular, the specification unit 21c can specify the second height at a position higher than the first height by a predetermined value. The predetermined value can be determined to be, for example, 0.2 m or the like, but can also be determined to be k times the entire thickness of the cargo loading pallet Cp to be used (k is a real number larger than 1).

The lifting or lowering control unit 21d controls the lifting or lowering of the fork Fb by controlling the driving by the fork drive unit 14. In particular, the lifting or lowering control unit 21d performs first lifting or lowering control of lifting or lowering the fork Fb in accordance with the weight acquired by the load amount acquisition unit 21a between the first height and the second height above the transfer place.

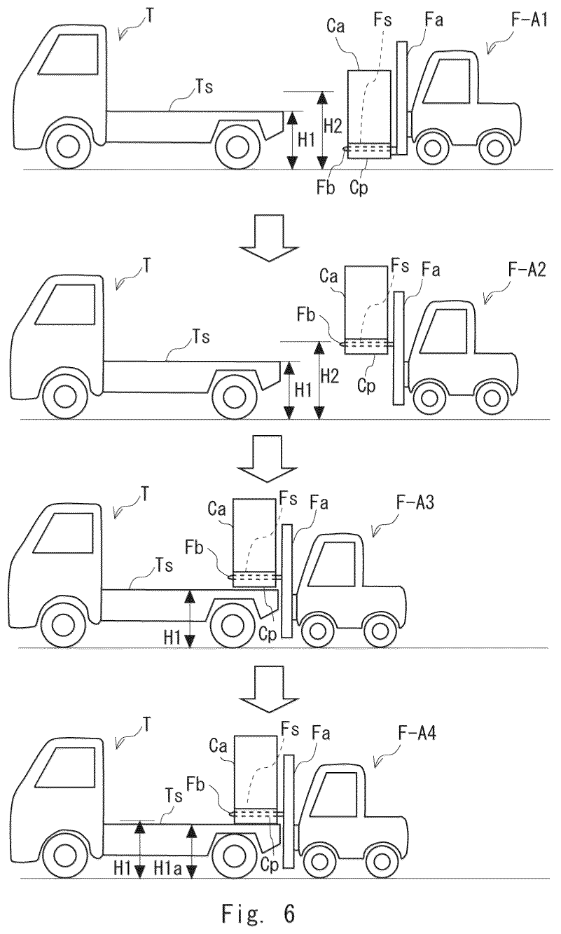

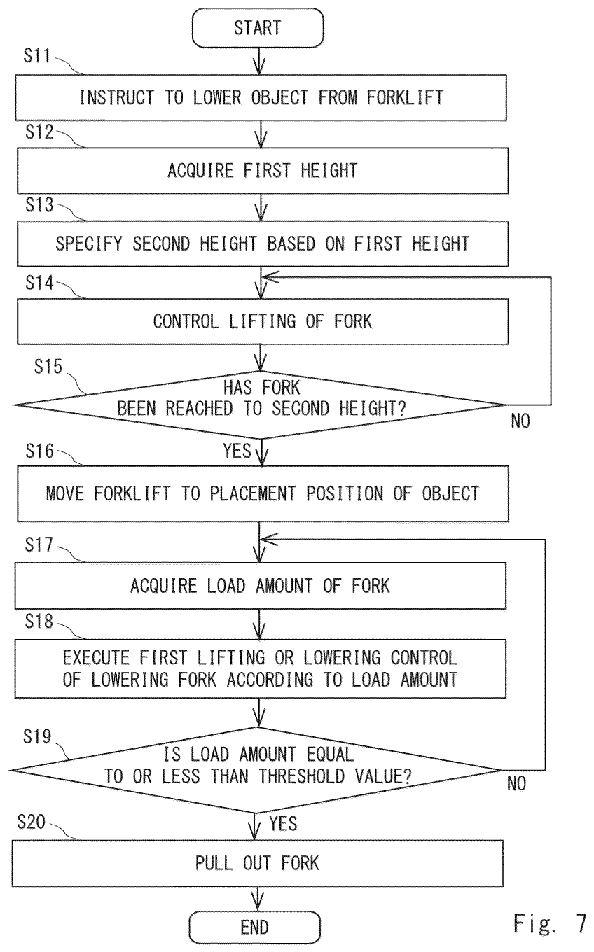

Next, an example of a procedure for lowering the object from the fork Fb will be described with reference to FIGS. 6 and 7. A scene where the object is lowered from the fork Fb (hereinafter, scene A) indicates a case where the fork Fb transfers the object to the transfer place. FIG. 6 is a schematic diagram for illustrating an example of a procedure for lowering the object from the fork Fb in the transfer control system 100 of FIG. 4, and FIG. 7 is a flowchart for illustrating a processing example in the transfer control system 100 in a case where the object is lowered in the procedure of FIG. 6.

In the scene A, first, the movement of the forklift F is designated by operation from the operation input unit 24 of the remote control apparatus 20, and the control unit 21 generates a command according to the designation and transmits the command to the forklift F via the communication unit 22. The forklift F receives the command via the communication unit 12, and the control unit 11 controls the wheel drive unit 13 to move according to the command and reach the vicinity of the truck T. This state refers to a state illustrated as a forklift F-A1 in the first stage of FIG. 6.

When the forklift F has a function of acquiring position information, the forklift F can automatically move to the vicinity of the truck T. However, here, an example will be described in which the operator causes the forklift F to reach the vicinity of the truck T by sequential remote operation from the operation input unit 24. The present disclosure is not limited to this, and in the present disclosure, the description thereof is omitted, but the forklift F may be moved by any control to reach the destination.

Next, an operation of an instruction to install the object on the truck T by the forklift F is received from the operation input unit 24 of the remote control apparatus 20 (step S11). The control unit 21 sequentially generates a command of an instruction according to the designation, that is, an object unloading instruction, and transmits the instruction to the forklift F via the communication unit 22. Note that, hereinafter, processing via the communication unit 12, the communication unit 22, and the communication unit 23 will be omitted, and will be described as exchange between apparatuses.

At this time, the acquisition unit 21b of the remote control apparatus 20 instructs the camera 30 capable of measuring the height H1 of the surface Ts of the loading platform of the truck T to measure the height H1, and as a result, receives the value of the height H1 (step S12). Next, the specification unit 21c specifies the height H2 based on the height H1 (step S13).

The lifting or lowering control unit 21d sequentially transmits a command for performing the second lifting or lowering control until reaching the second height H2 to the forklift F to perform the second lifting or lowering control (step S14). The second lifting or lowering control can be, for example, control to perform lifting at a constant speed. Note that, although it is originally assumed that the position of the fork Fb is on the lower side, in a case where the position is higher than the second height H2, the second lifting or lowering control can be control to lower the fork Fb at a constant speed until the second height H2 is reached.

The control unit 11 of the forklift F that has received this command sequentially controls the fork drive unit 14 to lift or lower the fork Fb. At this time, the forklift F feeds back the height of the fork Fb to the remote control apparatus 20 as necessary. Note that, in a case where the remote control apparatus 20 side has grasped in advance the action of the forklift F in response to the issued command, such height feedback is unnecessary. The lifting or lowering control unit 21d determines whether the second height H2 has been reached (step S15), and in a case where the second height H2 has not been reached, the processing returns to step S14, and the second lifting or lowering control is continuously performed.

If YES in step S15, the state illustrated as the forklift F-A2 is obtained in the second row from the top in FIG. 6. In this case, the lifting or lowering control unit 21d generates a command to temporarily stop the elevation control, and the control unit 21 generates a command to move the forklift F to the placement position of the object, and transmits these commands to the forklift F. In response to these commands, the control unit 11 controls the fork drive unit 14 to stop the lifting or lowering of the fork Fb, and controls the wheel drive unit 13 to move the forklift F to the placement position of the object (step S16). This state refers to a state illustrated as a forklift F-A3 in the third row from the top in FIG. 6.

At this time, the load amount acquisition unit 21a requests information indicating the weight from the forklift F, and the forklift F acquires the weight by the weight sensor 15 and returns the weight to the remote control apparatus 20 (step S17). Next, the lifting or lowering control unit 21d sequentially generates a command to perform control according to the weight of the fork Fb, that is, the first lifting or lowering control in a case where the height of the fork Fb is from the second height H2 to the first height H1 in a case where the fork Fb is on the upper side of the upper surface Ts of the loading platform. Then, the lifting or lowering control unit 21d transmits the sequentially generated command to the forklift F to perform the first lifting or lowering control (step S18).

In particular, in the present example embodiment, in step S18, as the first lifting or lowering control, a command to perform control according to the weight of the fork Fb is sequentially generated until the weight becomes equal to or less than the threshold value from the second height H2. Note that, theoretically, the determination that the weight is equal to or less than the threshold value may be a determination that the weight is zero. In addition, in the present example embodiment, in the case of lowering the object, as the first lifting or lowering control, control according to the weight can be performed until both the condition that the height becomes the first height H1 and the condition that the weight becomes equal to or less than the threshold value are satisfied. That is, in the present example embodiment, in the case of lowering the object, as the first lifting or lowering control, control according to the weight can be performed until at least one of the condition that the height becomes the first height H1 and the condition that the weight becomes equal to or less than the threshold value are satisfied. As described above, the first height H1 can be the height of the surface Ts of the loading platform of the truck T, or in a case where the cargo loading pallet Cp includes a plate-like frame also on the lower side as exemplified, the first height H1 can be the height obtained by adding the thickness of the frame. However, in at least the former case, the first height H1 may be a height obtained by adding the thickness of the fork Fb.

The control unit 11 of the forklift F that has received this command sequentially controls the fork drive unit 14 to lower the fork Fb. At this time, the forklift F sequentially monitors the weight with the weight sensor 15, and feeds back information indicating the weight to the remote control apparatus 20. In a case where the height of the fork Fb is determined, the current height of the forklift F is known, and thus the height may be fed back to the remote control apparatus 20 as necessary. The load amount acquisition unit 21a of the remote control apparatus 20 determines whether the weight has become equal to or less than the threshold value (step S19), and in a case where the determination is NO, the processing returns to step S17 and the lifting or lowering control unit 21d continues the control according to the weight.

On the other hand, in a case where the determination is YES in step S19, the remote control apparatus 20 transmits a command to pull out the fork Fb to the forklift F and move at that time or at a time when the fork Fb is lowered by a predetermined value from that time. Then, the forklift F pulls out and moves in accordance therewith (step S20).

By such control, the position of the fork Fb is lowered according to the weight until the weight becomes equal to or less than the threshold value, and the fork Fb comes into a state of being removed. This state refers to a state illustrated as a forklift F-A4 in the fourth row from the top in FIG. 6.

In this state, it can be seen that the surface Ts of the loading platform of the truck T has a height H1a lower than the height H1 measured first. This means that the surface Ts of the loading platform is lowered by the influence of the suspension of the wheel or the like according to the weight of the object. The height of the surface Ts of the loading platform gradually decreases until the weight becomes equal to or less than the threshold value after the bottom surface of the cargo loading pallet Cp abuts on the surface Ts of the loading platform. However, in the present example embodiment, since the first lifting or lowering control as described above is performed, it is possible to efficiently install the object in a situation where the installation surface changes depending on the weight of the conveyance object.

Note that by providing the control unit 11 with at least a part of the function of the lifting or lowering control unit 21d, information indicating the weight from the weight sensor 15 can be obtained, and the control unit 11 can perform the first lifting or lowering control on the fork drive unit 14 without the remote control apparatus 20.

In addition, in FIGS. 6 and 7, an example in which the fork Fb is raised to the second height H2 after the forklift F reaches the vicinity of the truck T has been described. However, the fork Fb can be raised to the second height H2 first and then can be caused to reach the vicinity of the truck T.

In addition, for example, the remote control apparatus 20 can be configured to automatically perform the installation simply by designating the object to be conveyed and the position thereof, the forklift F used for conveyance, and the truck at the installation destination. For example, the remote control apparatus 20 may detect the position of the truck with the camera 30 or the like, and the forklift F may automatically pick up the object according to the information from the remote control apparatus 20 and dispose the object on the loading platform of the truck. In addition, such designation can be configured to be automatically performed by introducing a transport management system.

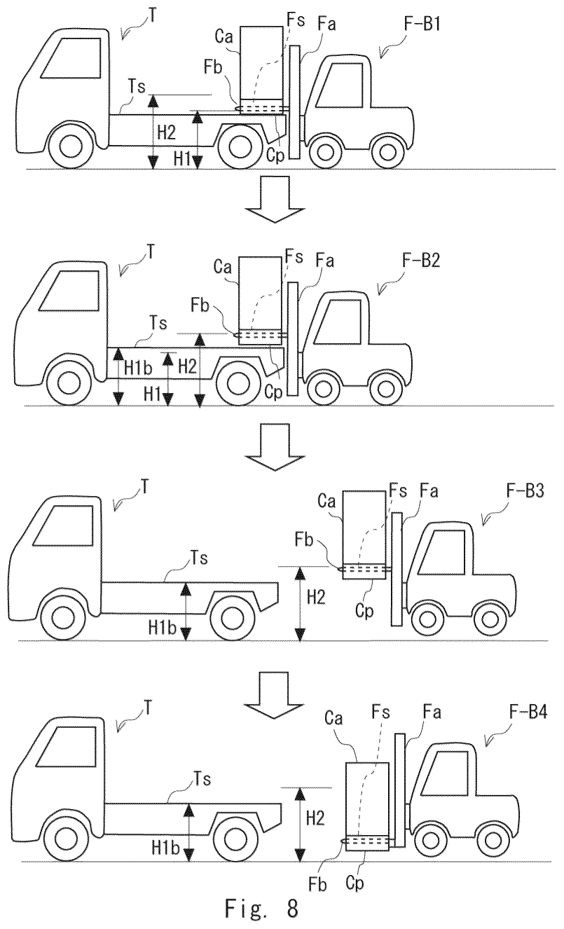

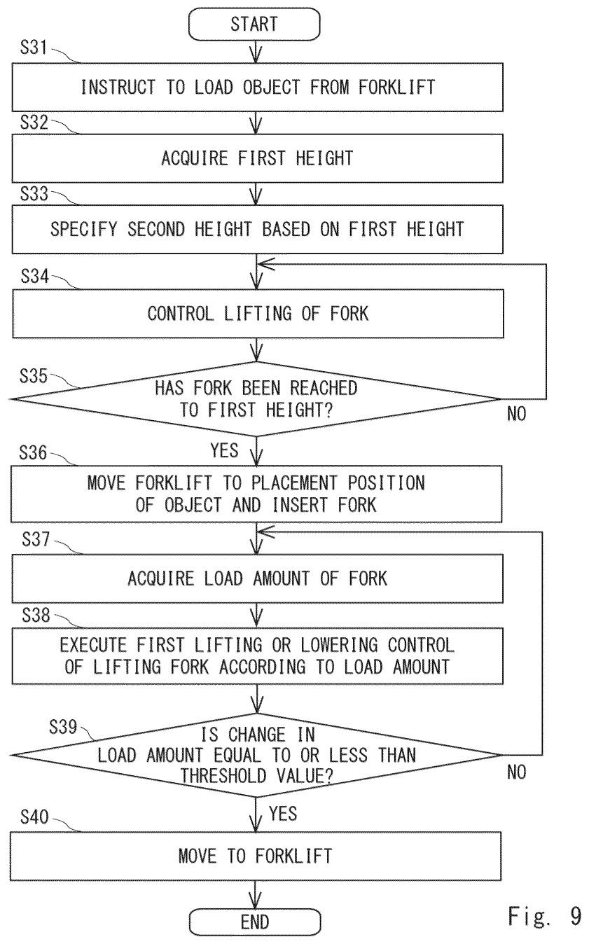

Next, an example of a procedure of loading the object on the fork Fb will be described with reference to FIGS. 8 and 9. The scene where the object is loaded on the fork Fb (hereinafter, scene B) refers to a scene where the object is picked up from the loading platform of the truck T by the fork Fb, and refers to a case where the fork Fb transfers the object from the transfer place. FIG. 8 is a schematic diagram for illustrating an example of a procedure for loading an object on the fork Fb in the transfer control system 100 of FIG. 4, and FIG. 9 is a flowchart for illustrating a processing example in the transfer control system in a case where the object is loaded in the procedure of FIG. 8.

In the scene B, first, the movement of the forklift F is designated by operation from the operation input unit 24 of the remote control apparatus 20, and the control unit 21 generates a command according to the designation and transmits the command to the forklift F. Upon receiving the command, the control unit 11 controls the wheel drive unit 13 to move in accordance with the command, and the forklift F reaches the vicinity of the truck T.

Next, the operation of the object loading instruction from the truck T by the forklift F, that is, the operation of the pickup instruction is received from the operation input unit 24 of the remote control apparatus 20 (step S31). The control unit 21 sequentially generates a command of an instruction according to the designation, that is, an instruction of the object loading instruction, and transmits the instruction to the forklift F.

At this time, the acquisition unit 21b of the remote control apparatus 20 instructs the camera 30 capable of measuring the height H1 of the surface Ts of the loading platform of the truck T to measure the height H1, and as a result, receives the value of the height H1 (step S32). The value of the height H1 obtained here is smaller than the value obtained in step S12 due to the weight of the object in a case where the truck T is the same. Next, the specification unit 21c specifies the height H2 based on the height H1 (step S33).

The lifting or lowering control unit 21d sequentially transmits a command for performing the second lifting or lowering control until reaching the first height H1 to the forklift F to perform the second lifting or lowering control (step S34). The second lifting or lowering control can be, for example, control to perform lifting at a constant speed. Note that, although it is originally assumed that the position of the fork Fb is on the lower side, in a case where the position is higher than the first height H1, the second lifting or lowering control can be control to lower the fork Fb at a constant speed until the first height H1 is reached. As described above, the first height H1 can be the height of the surface Ts of the loading platform of the truck T. However, since it is necessary to insert the fork Fb, the first height H1 may be the height obtained by adding the thickness of the fork Fb. Alternatively, in a case where the cargo loading pallet Cp also includes a plate-shaped frame on the lower side as exemplified, the first height H1 can be a height obtained by adding the thickness of the frame, and in this case, the first height H1 can also be a height obtained by adding the thickness of the fork Fb.

The control unit 11 of the forklift F that has received this command sequentially controls the fork drive unit 14 to lift or lower the fork Fb. At this time, the forklift F feeds back the height of the fork Fb to the remote control apparatus 20 as necessary. Note that, in a case where the remote control apparatus 20 side has grasped in advance the action of the forklift F in response to the issued command, such height feedback is unnecessary. The lifting or lowering control unit 21d determines whether the first height H1 has been reached (step S35), and in a case where the second height H2 has not been reached, the processing returns to step S34, and the second lifting or lowering control is continuously performed.

In a case where the determination is YES in step S35, the lifting or lowering control unit 21d generates a command to temporarily stop the lifting or lowering control, and the control unit 21 generates a command to move the forklift F to the placement position of the object and insert the fork Fb. Then, the control unit 21 transmits these commands to the forklift F. In response to these commands, the control unit 11 controls the fork drive unit 14 to stop the lifting or lowering of the fork Fb, and controls the wheel drive unit 13 to move the forklift F to the placement position of the object, thereby inserting the fork Fb (step S36). This state refers to a state illustrated as a forklift F-B1 in the first stage of FIG. 8.

At this time, the load amount acquisition unit 21a requests information indicating the weight from the forklift F, and the forklift F acquires the weight by the weight sensor 15 and returns the weight to the remote control apparatus 20 (step S37). Next, the lifting or lowering control unit 21d sequentially generates a command to perform control according to the weight of the fork Fb, that is, the first lifting or lowering control in a case where the height of the fork Fb is from the first height H1 to the second height H2 in a case where the fork Fb is on the upper side of the upper surface Ts of the loading platform. Then, the lifting or lowering control unit 21d transmits the sequentially generated command to the forklift F to perform the first lifting or lowering control (step S38).

In particular, in the present example embodiment, in step S38, as the first lifting or lowering control, a command to perform control according to the weight of the fork Fb is sequentially generated until the change in the weight from the first height H1 becomes equal to or less than the threshold value. Note that, theoretically, the determination that the change in weight is equal to or less than the threshold value may be a determination that the change in weight is zero. The fact that the change in weight is equal to or less than the threshold value indicates that the object is stably loaded on the fork Fb and the load is not in contact with the truck T. Therefore, the change in weight here being equal to or less than the threshold value excludes a case where the weight is equal to or less than the zero state threshold value. In addition, the lifting or lowering control unit 21d may acquire the weights of the cargo Ca and the cargo loading pallet Cp in advance by the load amount acquisition unit 21a, and determine that the cargo Ca is placed on the fork Fb when the load amount of the fork Fb becomes about the same as the weights of the cargo Ca and the cargo loading pallet Cp.

In addition, in the present example embodiment, in a case where the object is loaded on the fork Fb, as the first lifting or lowering control, the control according to the weight can be performed until both the condition that the height becomes the second height H2 and the condition that the change in the weight becomes equal to or less than the threshold value are satisfied. That is, in the present example embodiment, in a case where the object is loaded on the fork Fb, as the first lifting or lowering control, the control according to the weight can be performed until at least one of the condition that the height becomes the second height H2 and the condition that the change in the weight becomes equal to or less than the threshold value are satisfied.

The control unit 11 of the forklift F that has received this command sequentially controls the fork drive unit 14 to lift the fork Fb. At this time, the forklift F sequentially monitors the weight with the weight sensor 15, and feeds back information indicating the weight to the remote control apparatus 20. In a case where the height of the fork Fb is determined, the current height of the forklift F is known, and thus the height may be fed back to the remote control apparatus 20 as necessary. The load amount acquisition unit 21a of the remote control apparatus 20 determines whether the change in weight has become equal to or less than the threshold value (step S39), and in a case where the determination is NO, the processing returns to step S37 and the lifting or lowering control unit 21d continues the control according to the weight.

On the other hand, in a case where the determination is YES in step S39, a state indicated as a forklift F-B2 is obtained in the second row from the top in FIG. 8. Therefore, the remote control apparatus 20 transmits a command to move to the forklift F at that time or at a time when the fork Fb is raised by a predetermined value from that time. Then, the forklift F moves in accordance therewith (step S40).

By such control, the position of the fork Fb rises according to the weight until the change in the weight becomes equal to or less than the threshold value, and the forklift F can move without the object contacting the loading platform of the truck T. This state refers to a state illustrated as a forklift F-B3 in the third row from the top in FIG. 8.

In this state, it can be seen that the surface Ts of the loading platform of the truck T has a height H1b higher than the height H1 measured first. This means that the surface Ts of the loading platform has been lowered by the influence of the suspension of the wheel or the like according to the weight of the object, but has returned to the original state due to the disappearance of the object. The height of the surface Ts of the loading platform gradually increases until the change in weight from the state where the bottom surface of the cargo loading pallet Cp abuts on the surface Ts of the loading platform becomes equal to or less than the threshold value. However, in the present example embodiment, since the first lifting or lowering control as described above is performed, it is possible to efficiently load the object on the fork Fb in a situation where the installation surface changes depending on the weight of the conveyance object.

Then, after being separated from the truck T, the remote control apparatus 20 lowers the fork Fb and moves the fork Fb to the destination. This state refers to a state illustrated as a forklift F-B4 in the fourth row from the top in FIG. 8.

Note that by providing the control unit 11 with at least a part of the function of the lifting or lowering control unit 21d, information indicating the weight from the weight sensor 15 can be obtained, and the control unit 11 can perform the first lifting or lowering control on the fork drive unit 14 without the remote control apparatus 20.

In addition, in FIGS. 8 and 9, an example in which the fork Fb is raised to the first height H1 after the forklift F reaches the vicinity of the truck T has been described. However, the fork Fb can be raised to the first height H1 first and then can be caused to reach the vicinity of the truck T.

Although the specific examples have been described above with reference to FIGS. 6 to 9, the present example embodiment is not limited to these examples. For example, the remote control apparatus 20 can be configured to automatically pick up the object only by designating the position of the truck on which the object to be conveyed is loaded, the forklift F used for conveyance, and the position of the transport destination. For example, the remote control apparatus 20 may detect the position of the truck with the camera 30 or the like, and the forklift F may automatically pick up the object from the loading platform of the truck according to the information from the remote control apparatus 20 and install the object at the position of the transport destination. In addition, such designation can be configured to be automatically performed by introducing a transport management system.

In addition, in the present example embodiment, unlike a case where an object is lifted and a forklift is operated by manual operation, a skilled technique of a driver who is an operator is unnecessary. For example, in placing or picking up an object by a forklift, it is not necessary for a driver to visually confirm whether the object has been lifted or installed on a floor or a truck, and work efficiency can be improved as compared with a case where visual confirmation is performed particularly with emphasis on safety. Further, in the present example embodiment, since the forklift F is operated by the remote operation, the worker does not need to move to the position of the forklift F, and the working time can be shortened.

As described above, in the present example embodiment, an example in which the mobile body is a forklift has been mainly described. However, the configuration and shape of the forklift are not limited to those exemplified, and even a mobile body other than the forklift can be applied as long as a sensor for detecting a load amount can be provided.

Examples of the mobile body include a crane vehicle or a robot that hangs an object from a hole or the like provided in the object, a robot that holds a handle or the like provided in the object in the vertical direction and lifts or lowers the object with an arm, and a robot that can load the object on the arm or the like.

The loading unit in the case of the method of suspending the object corresponds to a hanging tool including a hook, a wire, and the like, and the sensor for detecting the load amount in this case can be installed in a winch portion of the hook or the wire. In this case, loading an object means that the object is hung and lifted by being hooked on a hanging tool under a part of the object, for example, a hole, or a protrusion provided in the object. In the case of a robot that grips an object in the vertical direction, a lower member of the grip portion corresponds to the loading unit, and a sensor that detects the load amount in this case can be provided on an upper surface of the lower member of the grip portion or an operating portion of an arm that pulls up the grip portion. In this case, loading the object corresponds to placing the object on the lower member of the grip portion and sandwiching the object with the upper member of the grip portion. In the case of a robot capable of loading cargo and cargo loading pallet on an arm or the like, similarly to the forklift, the loading unit corresponds to a portion on which an object is loaded, and an installation position of a sensor that detects a load amount may be the same as the forklift or may be an operating portion of the arm or the like. In this case, loading the object means loading the object on the arm or the like similarly to the forklift.

In addition, the type of the above mobile body is not limited to a mobile body that moves on the ground, and may be an object that moves under water or over water, such as a ship or an underwater drone, or an object (flight vehicle) that moves in the air, such as an aircraft or a flying drone. Furthermore, the mobile body may be a mobile robot such as an automated guided vehicle (AGV).

Further, it does not matter whether the mobile body has a function of moving according to autonomous control, a function of moving according to operation by an operator, or both functions. In a case in which the mobile body has a function of moving according to autonomous control, the mobile body performs automatic driving (autonomous driving) on the basis of information of various sensors mounted on the mobile body. Further, the mobile body may be configured to be able to switch between, for example, automatic driving and manual driving by an occupant (for example, a driver in a vehicle in the case of an automatic driving vehicle).

### Second Example Embodiment

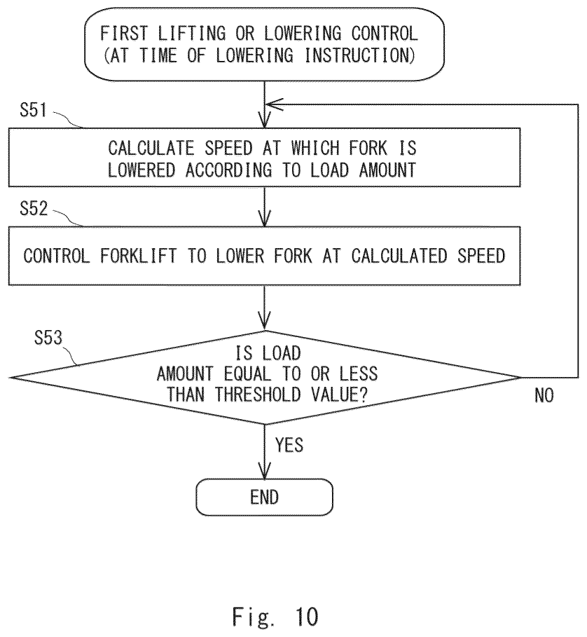

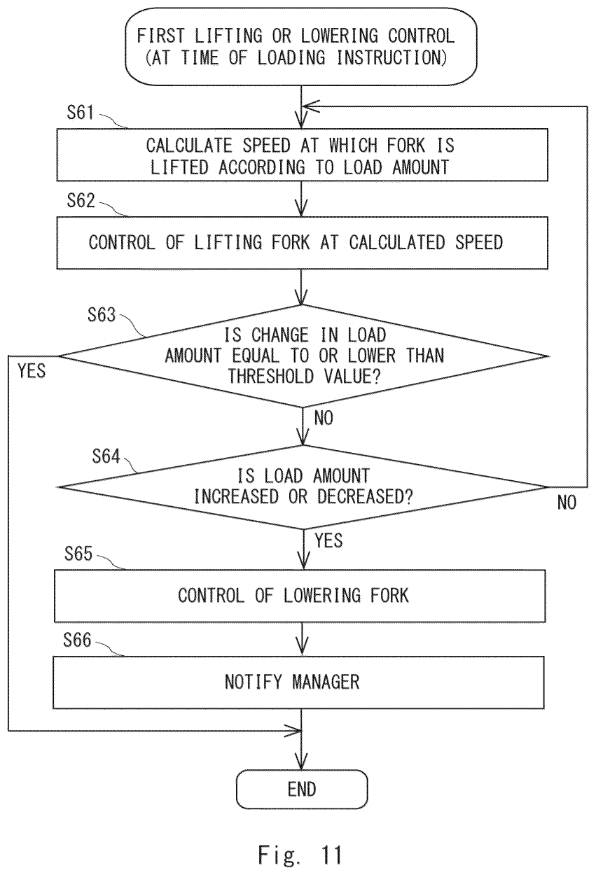

A second example embodiment will be described with reference to FIGS. 10 and 11, focusing on differences from the first example embodiment, but various examples described in the first example embodiment can be applied in the present example embodiment. In addition, since the function of the transfer control system according to the present example embodiment is the same as the function of the transfer control system 100 of FIG. 4 except for a part thereof, the present example embodiment will also be described based on the configuration example of FIG. 4 and the notation of the height and the like of FIGS. 6 and 8.

The first lifting or lowering control in the present example embodiment is different from that in the first example embodiment in that the first lifting or lowering control includes a control of changing the speed of lifting or lowering the fork Fb according to a change in the load amount.

First, an example of the first lifting or lowering control in the procedure of the scene A, that is, the procedure of lowering the object from the fork Fb will be described with reference to FIG. 10. FIG. 10 is a flowchart for describing an example of the transfer control method in the transfer control system 100 according to the example embodiment.

The lifting or lowering control unit 21d calculates the speed at which the fork Fb is lowered according to the load amount such as weight (step S51). Next, the lifting or lowering control unit 21d controls the forklift F to lower the fork Fb at the calculated speed (step S52). That is, when the load amount becomes light, the lifting or lowering control unit 21d performs control to lower the motion speed of the fork Fb according to the load amount, such as slowly lowering the fork Fb. According to this control, the fork Fb is lowered at the calculated speed in the forklift F. Next, the lifting or lowering control unit 21d determines whether the load amount such as the weight has become equal to or less than the threshold value (step S53), and ends the processing in the case where the determination is YES, and returns to step S51 in the case where the determination is NO. Note that the acquisition path and the like of the load amount such as the first height H1 and the weight are as described in FIGS. 6 and 7.

In this example, the fork Fb is controlled by the lifting or lowering control unit 21d as follows according to the load amount on the fork Fb.

When the load amount on the fork Fb decreases or is less than the threshold value (Th1), it is estimated that the object is in contact with the surface Ts of the loading platform of the truck T. Therefore, the speed of lowering the fork Fb according to the load amount is decreased to lower the fork Fb. In addition, in a case where the load amount on the fork Fb is equal to or less than the threshold value (Th2) smaller than Th1, it is estimated that the object has been separated from the fork Fb, that is, the object has been able to be installed. Therefore, the lowering of the fork Fb is stopped, and the fork Fb is pulled out. Furthermore, in a case where the change in the load amount on the fork Fb is equal to or less than the threshold value (Th3), it is estimated that the object is stably placed on the fork Fb, and thus the fork Fb is lowered. Of course, Th3 may be a value different from Th2 used at the time of determining the load amount.

As described above, it can be said that the lifting or lowering control unit 21d can determine the stability of the load of the object based on the change in the load amount as the first lifting or lowering control, and perform control to lift the fork Fb according to the determination result. Here, the stability can refer to a state such as whether the object is separated from the fork Fb or successfully placed on the fork Fb.

Next, an example of the first lifting or lowering control in the procedure of the scene B, that is, the procedure of loading the object on the fork Fb will be described with reference to FIG. 11. FIG. 11 is a flowchart for illustrating another example of a transfer control method in the transfer control system 100 according to the present example embodiment.

The lifting or lowering control unit 21d calculates the speed at which the fork Fb is raised according to the load amount such as weight (step S61). Next, the lifting or lowering control unit 21d controls the forklift F to lift the fork Fb at the calculated speed (step S62). That is, when the load amount becomes heavy, the lifting or lowering control unit 21d performs control to increase the motion speed of the fork Fb according to the load amount, such as quickly lifting the fork Fb. According to this control, the fork Fb is raised at the calculated speed in the forklift F. Next, the lifting or lowering control unit 21d determines whether the change in the load amount such as the weight has become equal to or less than the threshold value (step S63), and ends the process in a case of YES.

In a case where the determination is NO in step S63, the lifting or lowering control unit 21d determines whether the load amount has increased or decreased (step S64), and in a case where the determination is NO, the processing returns to step S61. Note that the increase or decrease refers to decrease after increase or increase after decrease. In addition, in step S64, it is also possible to determine whether the load amount is repeatedly increased or decreased a predetermined number of times or more. In a case where the determination is YES in step S64, the state is abnormal, and thus the lifting or lowering control unit 21d performs control to lower the fork Fb (step S65). Furthermore, in this case, the lifting or lowering control unit 21d or the control unit 21 notifies a terminal apparatus or the like registered in advance for the administrator via the communication unit 22 (step S66), and ends the processing. The order of steps S65 and S66 is not limited. Note that the acquisition path and the like of the load amount such as the second height H2 and the weight are as described in FIGS. 8 and 9.

As described above, it can be said that the lifting or lowering control unit 21d can determine the stability of the load of the object based on the change in the load amount as the first lifting or lowering control, and perform control to lift the fork Fb according to the determination result. In the example of FIG. 11, the fork Fb is controlled by the lifting or lowering control unit 21d as follows according to the load amount on the fork Fb.

When the load amount on the fork Fb increases or is equal to or greater than the threshold value (Th1), it is estimated that the object is placed on the fork Fb. Therefore, the speed at which the fork Fb is raised according to the load amount is increased and the fork Fb is raised. Furthermore, in a case where the change in the load amount on the fork Fb is equal to or less than the threshold value (Th3), it is estimated that the object is stably placed on the fork Fb, and thus the fork Fb maintains the state or lifts the object to a predetermined height. Thereafter, the forklift F is moved. In addition, in a case where the load amount on the fork Fb increases or decreases, it is estimated that the object is not stably placed on the fork Fb or the fork Fb is not stuck to the back, and thus the fork Fb is temporarily lowered and notified to the administrator.

As described above, according to the present example embodiment, in addition to the effects of the first example embodiment, finer lifting or lowering control can be performed in a state where there is a possibility that the state becomes unstable. Note that the various examples described in the present example embodiment can be applied to the first example embodiment only partially or entirely.

### Third Example Embodiment

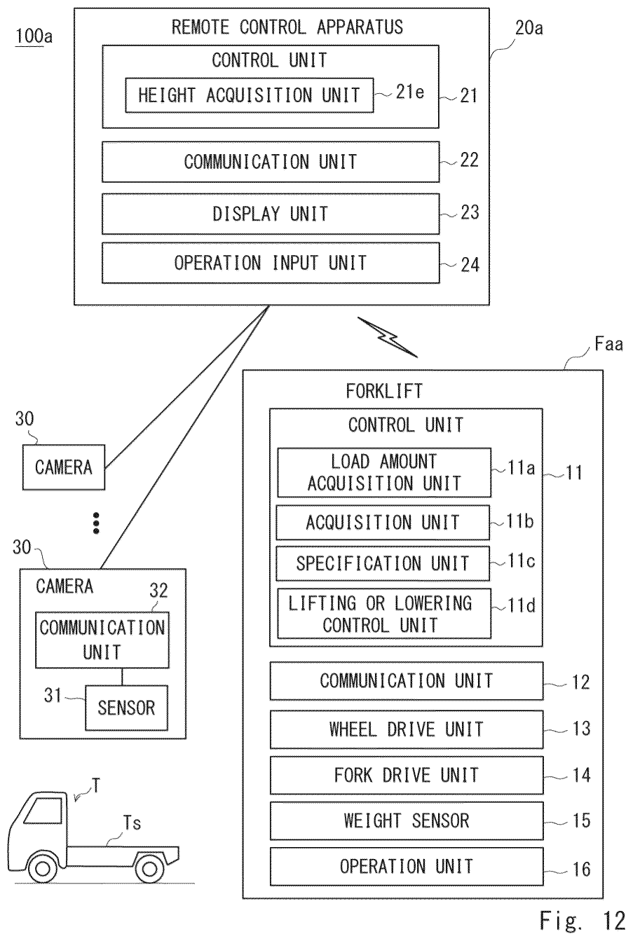

A third example embodiment will be described with reference to FIG. 12, focusing on differences from the first example embodiment, but various examples described in the first and second example embodiments can be applied in the present example embodiment. FIG. 12 is a block diagram illustrating a configuration of a transfer control system according to a second example embodiment.

As illustrated in FIG. 12, a transfer control system 100a according to the present example embodiment is a system in which a distribution form of functions is different from that of the transfer control system 100 illustrated in FIG. 4. The transfer control system 100a includes one or a plurality of cameras 30, a remote control apparatus 20a, and one or a plurality of forklifts Faa.

The remote control apparatus 20a includes a control unit 21 including a height acquisition unit 21e that acquires the first height from the camera 30, and also includes a communication unit 22, a display unit 23, and an operation input unit 24. In the forklift F of FIG. 4, the forklift Faa includes a load amount acquisition unit 11a, an acquisition unit 11b, a specification unit 11c, and a lifting or lowering control unit 11d in the control unit 11.

The load amount acquisition unit 11a acquires information indicating a weight from the weight sensor 15. The acquisition unit 11b acquires the first height acquired by the remote control apparatus 20a from the camera 30 from the remote control apparatus 20a via the communication unit 12. In addition, the acquisition unit 11b can also be configured to directly acquire the first height from the camera 30 via the communication unit 12. The specification unit 11c specifies the second height based on the first height. The lifting or lowering control unit 11d performs lifting or lowering control including the first lifting or lowering control on the fork drive unit 14. In addition, the description of FIG. 4 and the like of the first example embodiment can be cited for details of each component of the transfer control system 100a, and basically, only a path for exchanging information is different.

As described above, in the present example embodiment, in addition to the effects of the first example embodiment or the second example embodiment, a necessary function can be realized mainly by the forklift Faa alone. However, as described in the first example embodiment, the configuration of FIG. 4 and the configuration of FIG. 12 are not limited regardless of the form of function distribution.

For example, as described in the first example embodiment and the third example embodiment, the lifting or lowering control unit and the specification unit can be provided on the remote control apparatus side or the forklift side. However, either one of the lifting or lowering control unit and the specification unit can be dispersedly arranged on the remote control apparatus side and the forklift side. In addition, although the example in which the movement control of the forklift is arranged on the same side as the lifting control of the fork has been described, the movement control of the forklift and the lifting or lowering control of the fork can be arranged in a distributed manner. Further, as described above, all the components including the camera 30 can be mounted on the forklift. In addition, the functions that can be provided on the remote control apparatus side can also be provided in a cloud server or the like.

### (Others)

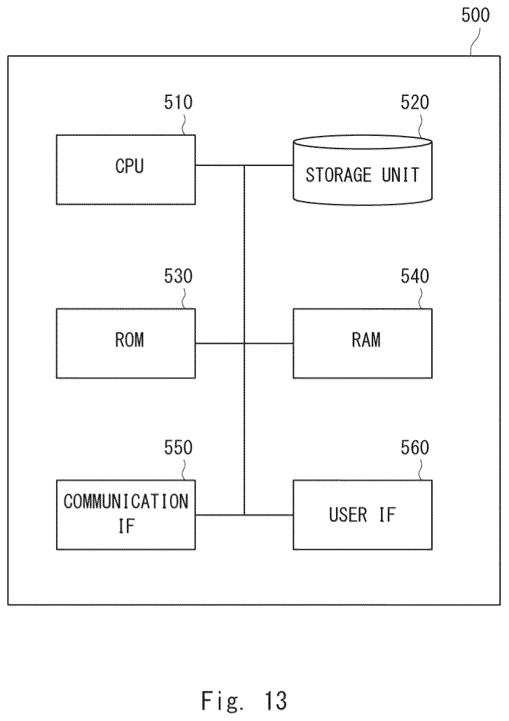

In the present disclosure, the transfer control apparatus, the remote control apparatus, the control unit of the forklift, the camera, and the like may include apparatuses such as a computer. FIG. 13 is a block diagram illustrating a configuration example of an apparatus. As illustrated in FIG. 13, an apparatus 500 includes a central processing unit (CPU) 510, a storage unit 520, a read only memory (ROM) 530, and a random access memory (RAM) 540 as a control unit. Further, the apparatus 500 may include a communication interface (IF) 550 and a user interface 560.

The apparatus 500 can be used as any of the transfer control apparatus, a remote control apparatus, a control unit of a forklift, and a camera. For example, the apparatus 500 can also be used as a control apparatus inside a forklift.

The communication interface 550 is an interface for connecting the apparatus 500 to a communication network through wired communication means, wireless communication means, or the like. The user interface 560 may include, for example, a display unit such as a display. Further, the user interface 560 may include input units such as a keyboard, a mouse, and a touch panel.

The storage unit 520 is an auxiliary storage device that can hold various types of data. The storage unit 520 need not to be necessarily part of the apparatus 500 and may be an external storage device or a cloud storage connected to the apparatus 500 via a network.

The ROM 530 is a non-volatile storage device. For example, a semiconductor storage device such as a flash memory having a relatively small capacity may be used for the ROM 530. A program that is executed by the CPU 510 may be stored in the storage unit 520 or the ROM 530. The storage unit 520 or the ROM 530 stores various programs for implementing the functions of the respective units in the apparatus 500.

The program includes a group of commands (or software codes) for causing a computer to perform one or more functions that have been described in the example embodiments when the program is read by the computer. The program may be stored in a non-transitory computer-readable medium or a tangible storage medium. As an example and not by way of limitation, a computer-readable medium or tangible storage medium includes a random-access memory (RAM), a read-only memory (ROM), a flash memory, a solid-state drive (SSD) or other memory technology, a compact disc (CD), a digital versatile disc (DVD), a Blu-ray (registered trademark) disk or other optical disk storage, a magnetic cassette, a magnetic tape, a magnetic disk storage, or other magnetic storage devices. The program may be transmitted on a transitory computer-readable medium or a communication medium. As an example and not by way of limitation, the transitory computer readable medium or the communication medium includes propagated signals in electrical, optical, acoustic, or any other form.

The RAM 540 is a volatile storage device. As the RAM 540, various types of semiconductor memory devices such as a dynamic random access memory (DRAM) or a static random access memory (SRAM) may be used. The RAM 540 may be used as an internal buffer for temporarily storing data or the like. The CPU 510 develops a program, stored in the storage unit 520 or the ROM 530, in the RAM 540, and executes the developed program. The function of each unit in the apparatus 500 can be realized by the CPU 510 executing the programs. The CPU 510 may include an internal buffer in which data or the like can be temporarily stored.

Although example embodiments according to the present disclosure have been described above in detail, the present disclosure is not limited to the above-described example embodiments, and the present disclosure also includes those that are obtained by making changes or modifications to the above-described example embodiments without departing from the spirit of the present disclosure.

For example, some or all of the above-described example embodiments may be described as the following supplementary notes, but the present disclosure is not limited to the following supplementary notes.

### (Supplementary Note 1)

A transfer control system including
lifting or lowering control means for controlling lifting or lowering of loading means for loading an object in a mobile body for conveying the object,
load amount acquisition means for acquiring a load amount of the loading means,
acquisition means for acquiring information relating to a first height that is a height of a place where the object is moved to and from the loading means, and
specification means for specifying a second height that is one of heights for lifting or lowering the loading means and is higher than the first height based on the first height,
in which the lifting or lowering control means performs a first lifting or lowering control of lifting or lowering the loading means according to the load amount between the first height and the second height above the place.

### (Supplementary Note 2)

The transfer control system according to Supplement 1, in which in a case where the loading means moves the object to the place, the lifting or lowering control means performs a second lifting or lowering control of lifting or lowering the loading means to the second height, and then performs the first lifting or lowering control until the load amount becomes equal to or less than a threshold value.

### (Supplementary Note 3)

The transfer control system according to Supplement 1 or 2, in which in a case where the loading means moves the object from the place, the lifting or lowering control means performs a second lifting or lowering control of lifting or lowering the loading means to the first height, and then performs the first lifting or lowering control until a change in the load amount becomes equal to or less than a threshold value.

### (Supplementary Note 4)

The transfer control system according to any one of Supplements 1 to 3, in which the first lifting or lowering control includes a control of changing a speed of lifting or lowering the loading means according to a change in the load amount.

### (Supplementary Note 5)

The transfer control system according to any one of Supplements 1 to 4, in which the specification means specifies the second height as a position higher than the first height by a predetermined value.

### (Supplementary Note 6)

The transfer control system according to any one of Supplements 1 to 5, in which
the loading means is carrying means for carrying the object,
the object includes cargo loading pallet including a frame forming a space in which the carrying means is inserted from a horizontal direction, and
the first height is a height obtained by adding a height of a lower frame of the cargo loading pallet to a height of a surface of a target to which the object is moved with respect to the carrying means.

### (Supplementary Note 7)

The transfer control system according to any one of Supplements 1 to 6, in which the acquisition means acquires a measurement value obtained by measuring a height of a surface of a target for moving the object with the loading means as the information regarding the first height.

### (Supplementary Note 8)

A transfer control apparatus including
lifting or lowering control means for controlling lifting or lowering of loading means for loading an object in a mobile body for conveying the object,
load amount acquisition means for acquiring a load amount of the loading means,
acquisition means for acquiring information relating to a first height that is a height of a place where the object is moved to and from the loading means, and
specification means for specifying a second height that is one of heights for lifting or lowering the loading means and is higher than the first height based on the first height,
in which the lifting or lowering control means performs a first lifting or lowering control of lifting or lowering the loading means according to the load amount between the first height and the second height above the place.

### (Supplementary Note 9)

The transfer control apparatus according to Supplement 8, in which in a case where the loading means moves the object to the place, the lifting or lowering control means performs a second lifting or lowering control of lifting or lowering the loading means to the second height, and then performs the first lifting or lowering control until the load amount becomes equal to or less than a threshold value.

### (Supplementary Note 10)

The transfer control apparatus according to Supplement 8 or 9, in which in a case where the loading means moves the object from the place, the lifting or lowering control means performs a second lifting or lowering control of lifting or lowering the loading means to the first height, and then performs the first lifting or lowering control until a change in the load amount becomes equal to or less than a threshold value.

### (Supplementary Note 11)

The transfer control apparatus according to any one of Supplements 8 to 10, in which the first lifting or lowering control includes a control of changing a speed of lifting or lowering the loading means according to a change in the load amount.

### (Supplementary Note 12)

The transfer control apparatus according to any one of Supplements 8 to 11, in which the specification means specifies the second height as a position higher than the first height by a predetermined value.

### (Supplementary Note 13)

The transfer control apparatus according to any one of Supplements 8 to 12, in which
the loading means is carrying means for carrying the object,
the object includes cargo loading pallet including a frame forming a space in which the carrying means is inserted from a horizontal direction, and
the first height is a height obtained by adding a height of a lower frame of the cargo loading pallet to a height of a surface of a target to which the object is moved with respect to the carrying means.

### (Supplementary Note 14)

The transfer control apparatus according to any one of Supplements 8 to 13, in which the acquisition means acquires a measurement value obtained by measuring a height of a surface of a target for moving the object with the loading means as the information regarding the first height.

### (Supplementary Note 15)

A transfer control method including
lifting or lowering control of controlling lifting or lowering of loading means for loading an object in a mobile body for conveying the object,
load amount acquisition processing of acquiring a load amount of the loading means,
acquisition processing of acquiring information relating to a first height that is a height of a place where the object is moved to and from the loading means, and
specification processing of specifying a second height that is one of heights for lifting or lowering the loading means and is higher than the first height based on the first height,
in which the lifting or lowering control includes a first lifting or lowering control of lifting or lowering the loading means according to the load amount between the first height and the second height above the place.

### (Supplementary Note 16)

The transfer control method according to Supplement 15, in which, in the lifting or lowering control, in a case where the loading means moves the object to the place, after performing a second lifting or lowering control of lifting or lowering the loading means to the second height, the first lifting or lowering control is performed until the load amount becomes equal to or less than a threshold value.

### (Supplementary Note 17)

The transfer control method according to Supplement 15 or 16, in which, in the lifting or lowering control, in a case where the loading means moves the object from the place, after performing the second lifting or lowering control of lifting or lowering the loading means to the first height, the first lifting or lowering control is performed until a change in the load amount becomes equal to or less than a threshold value.

### (Supplementary Note 18)

The transfer control method according to any one of Supplements 15 to 17, in which the first lifting or lowering control includes a control of changing a speed of lifting or lowering the loading means according to a change in the load amount.

### (Supplementary Note 19)

The transfer control method according to any one of Supplements 15 to 18, in which the specification processing is processing of specifying the second height as a position higher than the first height by a predetermined value.

### (Supplementary Note 20)

The transfer control method according to any one of Supplements 15 to 19, in which
the loading means is carrying means for carrying the object,
the object includes cargo loading pallet including a frame forming a space in which the carrying means is inserted from a horizontal direction, and
the first height is a height obtained by adding a height of a lower frame of the cargo loading pallet to a height of a surface of a target to which the object is moved with respect to the carrying means.

### (Supplementary Note 21)

The transfer control method according to any one of Supplements 15 to 20, in which the acquisition processing includes processing of acquiring a measurement value obtained by measuring a height of a surface of a target for moving the object with the loading means as the information regarding the first height.

### (Supplementary Note 22)

A program for causing a computer to execute a transfer control including
lifting or lowering control of controlling lifting or lowering of loading means for loading an object in a mobile body for conveying the object,
load amount acquisition processing of acquiring a load amount of the loading means,
acquisition processing of acquiring information relating to a first height that is a height of a place where the object is moved to and from the loading means, and
specification processing of specifying a second height that is one of heights for lifting or lowering the loading means and is higher than the first height based on the first height,
in which the lifting or lowering control includes a first lifting or lowering control of lifting or lowering the loading means according to the load amount between the first height and the second height above the place.

### (Supplementary Note 23)

The program according to Supplement 22, in which, in the lifting or lowering control, in a case where the loading means moves the object to the place, after performing a second lifting or lowering control of lifting or lowering the loading means to the second height, the first lifting or lowering control is performed until the load amount becomes equal to or less than a threshold value.

### (Supplementary Note 24)

The program according to Supplement 22 or 23, in which, in the lifting or lowering control, in a case where the loading means moves the object from the place, after performing the second lifting or lowering control of lifting or lowering the loading means to the first height, the first lifting or lowering control is performed until a change in the load amount becomes equal to or less than a threshold value.

### (Supplementary Note 25)

The program according to any one of Supplements 22 to 24, in which the first lifting or lowering control includes a control of changing a speed of lifting or lowering the loading means according to a change in the load amount.

### (Supplementary Note 26)

The program according to any one of Supplements 22 to 25, in which the specification processing is processing of specifying the second height as a position higher than the first height by a predetermined value.

### (Supplementary Note 27)

The program according to any one of Supplements 22 to 26, in which
the loading means is carrying means for carrying the object,
the object includes cargo loading pallet including a frame forming a space in which the carrying means is inserted from a horizontal direction, and
the first height is a height obtained by adding a height of a lower frame of the cargo loading pallet to a height of a surface of a target to which the object is moved with respect to the carrying means.

### (Supplementary Note 28)

The program according to any one of Supplements 22 to 27, in which the acquisition processing includes processing of acquiring a measurement value obtained by measuring a height of a surface of a target for moving the object with the loading means as the information regarding the first height.

### REFERENCE SIGNS LIST

Ca CARGO
Cp CARGO LOADING PALLET
Csb UPPER SURFACE OF LOWER FRAME
Csu LOWER SURFACE OF UPPER FRAME
F, Faa FORKLIFT
Fa LIFT PORTION
Fb FORK
Fs LOADING SURFACE
H1 FIRST HEIGHT
H2 SECOND HEIGHT
T TRUCK
Ts SURFACE OF LOADING PLATFORM
1, 100, 100a TRANSFER CONTROL SYSTEM
2 TRANSFER CONTROL APPARATUS
20, 20a REMOTE CONTROL APPARATUS
11,21 CONTROL UNIT
11a, 21a LOAD AMOUNT ACQUISITION UNIT
11b, 21b ACQUISITION UNIT
11c, 21c SPECIFICATION UNIT
11d, 21d LIFTING OR LOWERING CONTROL UNIT
12, 22, 32 COMMUNICATION UNIT
13 WHEEL DRIVE UNIT
14 FORK DRIVE UNIT
15 WEIGHT SENSOR
16 OPERATION UNIT
21e HEIGHT ACQUISITION UNIT
23 DISPLAY UNIT
24 OPERATION INPUT UNIT
30 CAMERA
31 SENSOR
500 APPARATUS
510 CPU
520 STORAGE UNIT
530 ROM
540 RAM
550) COMMUNICATION INTERFACE
560 USER INTERFACE

What is claimed is:

1. A transfer control system comprising:
at least one memory storing instructions; and
at least one processor configured to execute the instructions to do transfer control process, wherein the transfer control process includes:
controlling lifting or lowering of a loading portion for loading an object in a mobile body for conveying the object;
acquiring a load amount of the loading portion;
acquiring information relating to a first height that is a height of a place where the object is moved to and from the loading portion; and
specifying a second height that is one of heights for lifting or lowering the loading portion and is higher than the first height based on the first height,
wherein the controlling lifting or lowering includes a first control of lifting or lowering the loading portion according to the load amount between the first height and the second height above the place.

2. The transfer control system according to claim 1, wherein, in the controlling lifting or lowering, in a case where the loading portion moves the object to the place, after performing a second control of lifting or lowering the loading portion to the second height, the first control is performed until the load amount becomes equal to or less than a threshold value.

3. The transfer control system according to claim 1, wherein, in the controlling lifting or lowering, in a case where the loading portion moves the object from the place, after performing a second control of lifting or lowering the loading portion to the first height, the first control is performed until a change in the load amount becomes equal to or less than a threshold value.

4. The transfer control system according to claim 1, wherein the first control includes a control of changing a speed of lifting or lowering the loading portion according to a change in the load amount.

5. The transfer control system according to claim 1, wherein the specifying is specifying the second height as a position higher than the first height by a predetermined value.

6. The transfer control system according to claim 1, wherein
the loading portion is a carrying portion for carrying the object,
the object includes cargo loading pallet including a frame forming a space in which the carrying portion is inserted from a horizontal direction, and
the first height is a height obtained by adding a height of a lower frame of the cargo loading pallet to a height of a surface of a target to which the object is moved with respect to the carrying portion.

7. The transfer control system according to claim 1, wherein the acquiring information is acquiring a measurement value obtained by measuring a height of a surface of a target for moving the object with the loading portion as the information regarding the first height.

8. A transfer control apparatus comprising:
at least one memory storing instructions; and
at least one processor configured to execute the instructions to do transfer control process, wherein the transfer control process includes:
controlling lifting or lowering of a loading portion for loading an object in a mobile body for conveying the object;
acquiring a load amount of the loading portion;
acquiring information relating to a first height that is a height of a place where the object is moved to and from the loading portion; and
specifying a second height that is one of heights for lifting or lowering the loading portion and is higher than the first height based on the first height,
wherein the controlling lifting or lowering includes a first control of lifting or lowering the loading portion according to the load amount between the first height and the second height above the place.

9. The transfer control apparatus according to claim 8, wherein, in the controlling lifting or lowering, in a case where the loading portion moves the object to the place, after performing a second control of lifting or lowering the loading portion to the second height, the first control is performed until the load amount becomes equal to or less than a threshold value.

10. The transfer control apparatus according to claim 8, wherein, in the controlling lifting or lowering, in a case where the loading portion moves the object from the place, after performing a second control of lifting or lowering the loading portion to the first height, the first control is performed until a change in the load amount becomes equal to or less than a threshold value.

11. The transfer control apparatus according to claim 8, wherein the first control includes a control of changing a speed of lifting or lowering the loading portion according to a change in the load amount.

12. The transfer control apparatus according to claim 8, wherein the specifying is specifying the second height as a position higher than the first height by a predetermined value.

13. The transfer control apparatus according to claim 8, wherein
the loading portion is a carrying portion for carrying the object,
the object includes cargo loading pallet including a frame forming a space in which the carrying portion is inserted from a horizontal direction, and
the first height is a height obtained by adding a height of a lower frame of the cargo loading pallet to a height of a surface of a target to which the object is moved with respect to the carrying portion.

14. The transfer control apparatus according to claim 8, wherein the acquiring information is acquiring a measurement value obtained by measuring a height of a surface of a target for moving the object with the loading portion as the information regarding the first height.

15. A transfer control method comprising:
controlling lifting or lowering of a loading portion for loading an object in a mobile body for conveying the object;
acquiring a load amount of the loading portion;
acquiring information relating to a first height that is a height of a place where the object is moved to and from the loading portion; and
specifying a second height that is one of heights for lifting or lowering the loading portion and is higher than the first height based on the first height,
wherein the controlling lifting or lowering includes a first control of lifting or lowering the loading portion according to the load amount between the first height and the second height above the place.

16. The transfer control method according to claim 15, wherein, in the controlling lifting or lowering, in a case where the loading portion moves the object to the place, after performing a second control of lifting or lowering the loading portion to the second height, the first control is performed until the load amount becomes equal to or less than a threshold value.

17. The transfer control method according to claim 15, wherein, in the controlling lifting or lowering, in a case where the loading portion moves the object from the place, after performing a second control of lifting or lowering the loading portion to the first height, the first control is performed until a change in the load amount becomes equal to or less than a threshold value.

18. The transfer control method according to claim 15, wherein the first control includes a control of changing a speed of lifting or lowering the loading portion according to a change in the load amount.

19. The transfer control method according to claim 15, wherein the specifying is specifying the second height as a position higher than the first height by a predetermined value.

20. The transfer control method according to claim 15, wherein
the loading portion is a carrying portion for carrying the object,
the object includes cargo loading pallet including a frame forming a space in which the carrying portion is inserted from a horizontal direction, and
the first height is a height obtained by adding a height of a lower frame of the cargo loading pallet to a height of a surface of a target to which the object is moved with respect to the carrying portion.

21. (canceled)
